(19) United States
(12) Patent Application Publication
(10) Pub. No.: US 2013/0235394 A1
(43) Pub. Date: Sep. 12, 2013

(54) PRINTING IMAGES ON A RETRANSFER MATERIAL HAVING A PREDISPOSED ARTIFACT

(71) Applicant: Jeanette E. Jordan, (US)

(72) Inventors: James M. Jordan, Eagan, MN (US); Richard D. Nubson, Eden Prairie, MN (US); Jason Fier, Prior Lake, MN (US)

(73) Assignee: DATACARD CORPORATION, Minnetonka, MN (US)

(21) Appl. No.: 13/876,600

(22) PCT Filed: Sep. 28, 2010
(86) PCT No.: PCT/US10/50517

§ 371 Date: Mar. 28, 2013

(51) Int. Cl. G06K 15/02

(52) U.S. Cl. CPC G06K 15/021
USPC 358/1.5; 358/1.12; 235/487

(57) ABSTRACT

A method, printer, and retransfer material have the capability of printing images, including multiple color images, on a retransfer material that already has a preprinted artifact on the retransfer material. The preprinted artifact can include for example a hologram or other registered artifact, More particularly, a method, printer, and retransfer material allow for printing images on a retransfer material, where such images are not printed onto the preprinted artifacts present on the retransfer material. One or more indicia marks are detected by at least one sensor, so as to obtain the position of respective preprinted artifacts before printing images onto the retransfer material. Such can avoid printing images on the preprinted artifacts, The method, printer, and retransfer material may be incorporated as part of an identification document issuance system, where the method and printer can be applied to one processing module of such a system.

### FIELD

This disclosure generally pertains to the field of printing images on a retransfer material having a predisposed artifact on the retransfer material, and more particularly to using such a retransfer material for printing personalized identity documents, such as for instance plastic cards including financial (e.g. credit and debit) cards, drivers' licenses, national identification cards, and other cards which bear personalized data unique to the card holder and/or which bear other card or document information.

### BACKGROUND

Card personalization systems and methods used in producing personalized cards and/or other personalized identity documents have been employed by institutions that issue such documents. Identity cards and/or documents, include for example plastic and composite cards, such as for instance financial (e.g. credit and debit) cards, drivers' licenses, national identification cards, and other cards and documents which are personalized with information unique to the intended document holder, and the like.

Card personalization systems and methods can be designed for small scale, individual card personalization and production. In these systems, a single card to be personalized is input into a personalization machine, which typically includes one or two personalization/production capabilities, such as printing and laminating.

For large volume batch production of cards, institutions often utilize systems that have multiple personalization/production capabilities, by employing multiple processing stations or modules to process a large number of cards at the same time to reduce the overall per card processing time. Examples of such systems are well known and have been on the market, for example by DataCard Corporation of Minneapolis, Minn. Common to each of these types of systems is an input with the ability to hold a relatively large number of cards that are to be personalized/produced, a plurality of personalization/production stations through which each card is directed to undergo a personalization/production operation, and an output that holds the personalized cards. A controller is typically employed to transfer data information and instructions for operating the input, the personalization/production stations, and the output. As with small scale card personalization machines, batch production systems also include printing and laminating capabilities.

Among the capabilities of such card issuance systems (either small or batch production), there is still a need for a capability to print images, including multiple color images, on a retransfer material that already has a predisposed artifact, including for example a hologram or other preprinted artifact. More particularly, there is still a need to be able to produce personalized identification documents or cards on a continuous web with a preprinted hologram registered on a specific spot with respect to the image(s) to be printed on the web, without requiring the need for additional personalization modules or stations.

### SUMMARY

The technical disclosure, as described hereinbelow, provides a solution for a printer, which may be used as a processing station or module in an identification document issuance system, and which has the capability of printing images, including multiple color images, on a retransfer material that already has a preprinted artifact, including for example a hologram or other registered artifact.

Generally, a method, a printer, and retransfer material are described that allow for printing images on a retransfer material having a preprinted artifact, such that the preprinted artifact will be in the correct position after the image has been printed. One or more indicia marks are detected by at least one sensor, so as to obtain the position of respective preprinted artifacts before printing images onto the retransfer material. Once the indicia mark passes through the photocell a configurable offset may be used to further position and adjust the retransfer material under the first print head being used by that particular print job, so that the preprinted artifact will be in the correct position after the image has been printed. In some instances it is desirable to avoid printing images on the preprinted artifacts.

In one embodiment, a method for printing an image on a retransfer material for subsequent transfer onto an identification document includes the following general steps. A retransfer material is passed through a sensor. The retransfer material has an indicia mark thereon. The indicia mark is detected by the sensor to obtain a position of a predisposed artifact on a surface of the retransfer material. The retransfer material is positioned with respect to a print head of a printer, based on the position of the predisposed artifact. An image is printed onto the retransfer material. In some instances, the image is printed such that it is not printed onto the predisposed artifact.

In one embodiment, the steps of passing, sensing, and positioning occur only once with respect to a first print head in a plurality of print heads, and prior to printing a first image on the retransfer material. In such a configuration, a single print command is issued to allow synchronous printing among the plurality of print heads.

In another embodiment, the steps of passing, sensing, and positioning occur for each print head in a plurality of print heads. In such a configuration, a separate print command is independently issued to each print head to allow printing at the respective print head, when the steps of passing, sensing, and positioning have been satisfied at the respective print head.

In appropriate circumstances, the step of positioning can also include applying a configurable offset to adjust the retransfer material to the print head.

A printer may be constructed so as to carry out the method for printing an image on a retransfer material. In one embodiment, such a printer can include at least one print station and a print head for each print station. A sensor is disposed proximate at least one of the print stations. The sensor is positioned prior to an upstream side of the print head, and is configured to determine a position of a predisposed artifact on a retransfer material. A control is configured to issue a command to position the retransfer material with respect to the print head based on the position of the predisposed artifact. The control is also configured to issue a command to the print head to print an image on the retransfer material. In some instances, the image is printed such that it is not printed onto the predisposed artifact.

In appropriate circumstances, the printer may be incorporated as one of two or more card processing modules in a card issuance system for producing identification documents.

The method and printer can employ a unique retransfer material. In one embodiment, a retransfer material is a roll of web material with a plurality of panels. Each panel has a major area with a designated printing area. At least one predisposed artifact is arranged within the major area of at least one panel, but outside the respective designated printing area. A code portion is disposed outside of each respective panel. The code portion identifies at least one image to be printed on the respective panel. An indicia mark is outside at least one panel having the predisposed artifact, and is indicative of the predisposed artifact. In some instances, printing does not occur on the predisposed artifact.

### BRIEF DESCRIPTION OF THE DRAWINGS

FIG. 1 is a flow chart showing a general implementation for printing images on a retransfer web material having a predisposed artifact thereon.

FIG. 2 is an embodiment of a printer that may be employed, for example, as a module in a card issuance system.

FIG. 3 is an embodiment of retransfer web material that may be employed, for example in the printer of FIG. 1, and that shows a predisposed artifact on a surface of the retransfer material.

### DETAILED DESCRIPTION

Generally, the following description, with reference to the above Figures, describes printing images on a retransfer material that already has a preprinted artifact on the retransfer material. For example, the following describes the capability of printing images, including multiple color images, on a retransfer material that already has a preprinted artifact on the retransfer material. More particularly, printing images on a retransfer material having a preprinted artifact is described, such that the preprinted artifact will be in the correct position after the image has been printed.

In some instances, such images are not printed onto the preprinted artifacts present on the retransfer material.

The preprinted artifact can include for example a hologram or other registered artifact, such as a document/card issuer's name and/or logo. The term “registered” simply refers to the fact that the artifact (or hologram) is located in the same spot for every document/card of a certain type. The “registered” spot may differ from one document/card type to another. Such artifacts (or holograms) can include but are not limited to a card issuer's name and/or logo, as well as any preprinted text or logo. In some circumstances, such preprinted text may be printed in special security inks, such as intaglio prints, color shifting or polarized inks, etc.).

Generally, one or more indicia marks on the retransfer material are detected by at least one sensor. Detection of the indicia mark(s) by a sensor obtains the position of respective preprinted artifacts before printing images onto the retransfer material. The position can be relayed to a controller, which controls a print head of a printer to print images on the retransfer material so that the preprinted artifact will be in the correct position after the image has been printed. Where appropriate, the concepts described herein may be incorporated, for example, as a part of an identification document issuance system. It will be appreciated that, whenever appropriate, the descriptions herein may be applied to other printing implementations that do not include processing of identification documents.

### Embodiments of Methodology/Implementations

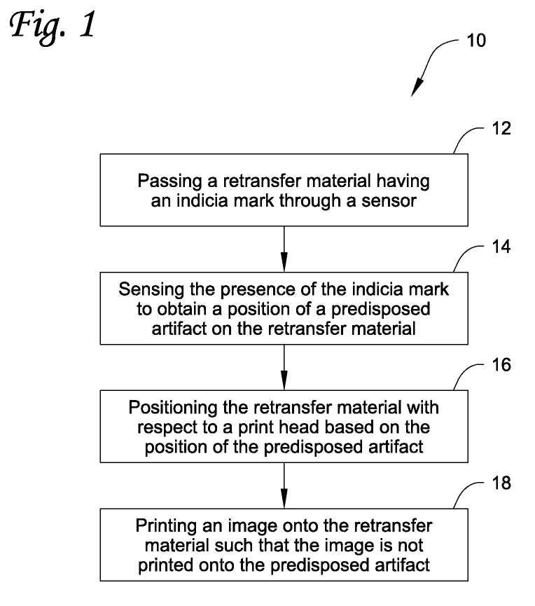

With reference to FIG. 1, a flow chart illustrates a general embodiment of a method 10 for printing an image or images on a retransfer material that already has a preprinted artifact on the retransfer material. The retransfer material in many instances is aimed at subsequent transfer of the images and preprinted artifacts onto an identification document.

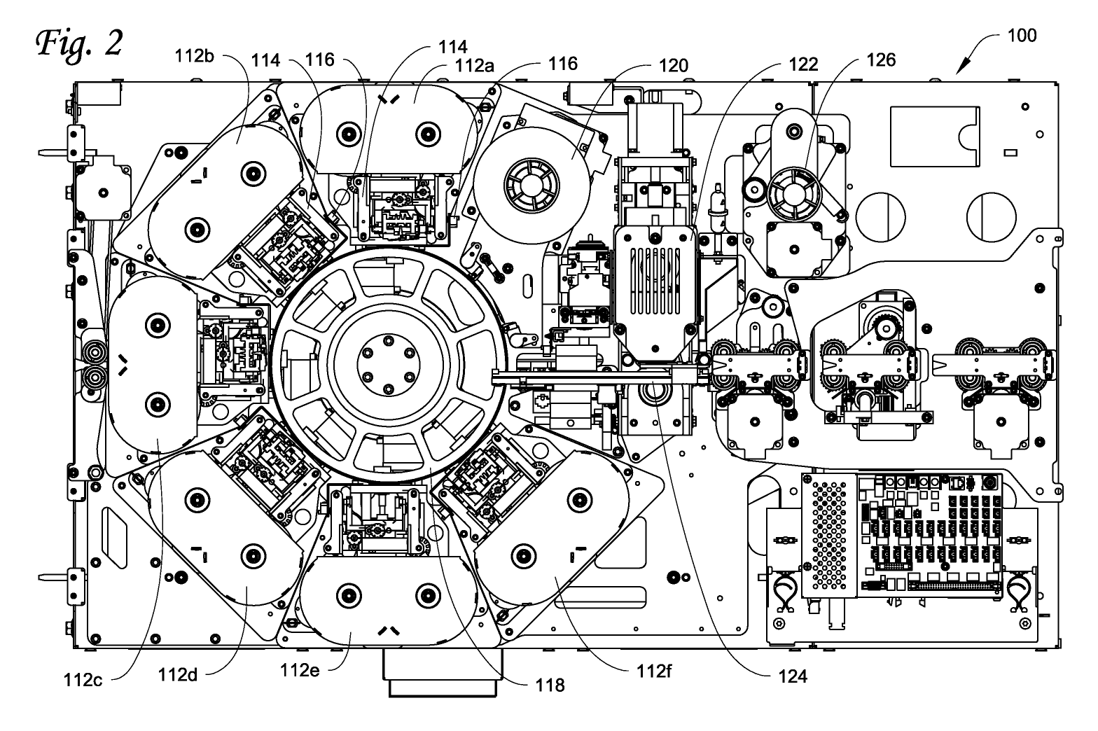

In the embodiment shown, a retransfer material is passed through a sensor 12. In one embodiment, the retransfer material has an indicia mark thereon so that the sensor can detect the indicia mark. The indicia mark is then detected by the sensor 14 to obtain a relative position of a predisposed artifact on a surface of the retransfer material. The retransfer material is then positioned with respect to a print head of a printer 16. One example of a printer 100 is shown in FIG. 2, which is further described below.

With further reference to the step of positioning the retransfer material, the step of positioning is based on the position of the predisposed artifact. In some embodiments, the step of positioning can also include applying a configurable offset to more accurately adjust the retransfer material to the print head. In certain instances, such adjustment may be needed if the retransfer material has been slightly shifted out of position.

After positioning of the retransfer material, an image is printed onto the retransfer material 18, where in many cases the image is not printed onto the predisposed artifact.

While it may be desired in many cases not to print over the predisposed artifact there may be instances, where it is required (or desirable) to do so. This should not be precluded in this embodiment. The objective in either case is to produce an output that has the predisposed artifact located in the correct location on every card produced.

It will be appreciated that the retransfer material can include a plurality of predisposed artifacts thereon, where it is desired to avoid printing on any of the predisposed artifacts. It also will be appreciated that the step of printing may include printing a plurality of images on the retransfer material.

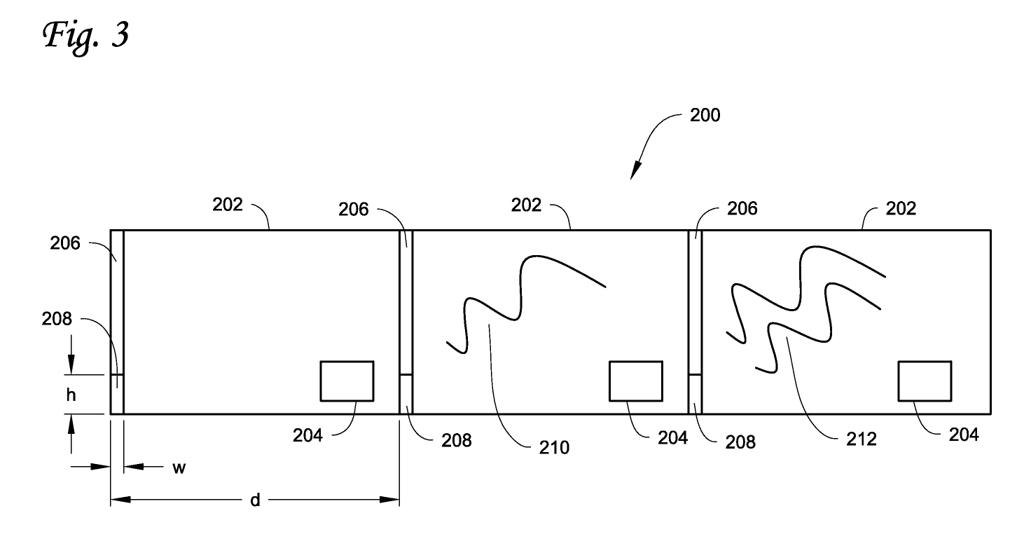

In some embodiments, the step of printing includes printing at least one image on multiple panels of the retransfer material. Each panel has a major area with a designated printing area within the major area of the respective panel. At least one predisposed artifact is disposed within the major area of one or more of the panels on the retransfer material. But the predisposed artifact is disposed outside the respective designated printing area. An example of a retransfer material is shown in FIG. 3, which is further described below.

Depending on the control used for implementing the general method, the retransfer material may be registered only once, for instance, at the beginning of each print cycle or after a stop condition of a printer, or may be registered multiple times during a print cycle.

The term “print cycle” is meant as a collection of control sequences that must be performed in order to generate a single printed color canvas, or one panel on the retransfer material. For example, for the printer of the printer of FIG. 2, six print cycles can be simultaneously executed in order to print the Cyan, Magenta, Yellow, Black, Spot, and Primer canvases for six different images at one time. For example, while the Primer head is executing the print cycle required to apply the primer material on Image #1, the Spot head is executing a print cycle (at the same time) required to apply the Spot color canvas to Image #2. The Black head will be executing a print cycle at the same time to apply the Black canvas to Image #3, while the Yellow, Magenta, and Cyan heads are executing a print cycle to print the Yellow, Magenta and Cyan canvases to Images #4, 5, and 6 respectively. All six print cycles can occur at the same time, when a panel of the retransfer material is in position. On completion of their print cycles each head repeats its print cycle on the next sequential image (Cyan starts image 7, Magenta starts image 6, Yellow starts image 5, etc).

When the retransfer material is registered only once, for example, the steps of passing, sensing, and positioning occur only once with respect to a first print head in a plurality of print heads, and prior to printing a first image on the retransfer material, such that a single print command is issued to allow synchronous printing among the plurality of print heads.

The term “registered only once” refers to the fact that a sensor is used, which may already exist in the machine, and is physically located before (upstream) the first print head. At the start of a print job, or a restart after a pause or error, the retransfer material will be passed through this sensor until a registration mark is detected. Once detected, a (configurable) offset will be applied. The offset will describe the distance between the sensor and the first print head. Once the retransfer material has travelled the offset distance, printing will begin. The registered sensor will not be used again until printing is paused due to error or the end of a print job. For example, in this embodiment, the predisposed artifact is only registered once at the beginning of the print job and only in reference to the first print head. Offset configurations that already exist provide the distance between each of the subsequent print heads. Those offsets will continue to be used in order to align the different color canvases that make up each image (e.g. Cyan, Magenta, Yellow, Black, Spot, and Primer).

A variant of the same embodiment would allow for the registration mark to be reregistered at an interval specified by the operator as a configuration parameter. This may be desirable if the distance between registration marks is not held within tight enough tolerances.

In other control implementations, the retransfer material may be registered multiple times during a print cycle. For example, the steps of passing, sensing, and positioning occur at each print head in a plurality of print heads, such that a separate print command is independently issued to each print head to allow printing at the respective print head, when the steps of passing, sensing, and positioning have been satisfied at the respective print head.

It will be appreciated that the control implementation in some embodiments is a local print control board and driver of a print head, which is controlled by a control board of a printer module. The firmware of such control boards can be configured as needed and/or desired to carry out either control implementation (i.e. single print command or separate print command) described above, including applying any needed configurable offset to more accurately adjust the retransfer material to the print head. For example, various local control boards and drivers, as well as module control boards are available and can be modified as needed to obtain the desired control implementation.

Such an implementation makes it possible, when appropriate or desired, to register each predisposed artifact and handle each color print cycle separately. Doing so can potentially ease a tight tolerance that may be present in the placement of the predisposed artifact on the retransfer web and could allow varying placement of artifacts, somewhat or almost randomly on the web, for example as long as the artifacts are the same or further apart than a width of a print canvas (or document/card).

### Embodiments of Printer

With reference to FIG. 2, one embodiment of a printer 100 is illustrated which may implement any of the methods described above. As one example, the printer 100 is capable of printing an image or images on a retransfer material 120, which can be subsequently transferred onto an identification document. The printer 100 includes at least one print station. As shown, the printer includes six print stations 112a-112f, configured to allow for printing multiple color images. The printer 100 can be configured to print multiple images on the retransfer material, including color images.

For example, each print station of the printer is dedicated to a single color, e.g. cyan, magenta, yellow, key (or black), and where at least one of the other two stations can be used for spot color. The sixth print head may be used for putting a primer material, such as an adhesive and/or thermally active resin layer, on the retransfer web material. Each print station includes a print head 114. A sensor 116 is disposed proximate at least one of the print stations 12a-f. As shown, one sensor 116 is positioned prior to an upstream side of each print head 114. In the embodiment shown, each print head 114 has a sensor 116, e.g. six sensors 116 one for each print head 114. Such a configuration as shown may be employed in the control implementation where each print head 114 is independently controlled. For example, as described above, the control can be configured to position the retransfer material 120 at each print head 112a-f, and the control is configured such that a separate print command is independently issued to each print head 112a-f to allow printing at the respective print head, when the retransfer material 120 has been positioned. Local control boards are well known and may be configured to carry out the needed control, and may be located, for example, below the printer 100.

However, it will be appreciated that depending on the control implementation that only one sensor 116 may be used for the first print station 112a, such as for the single print command control implementation. For example, as described above, the control can be configured to position the retransfer material 120 only once with respect to the first print head 112a in a plurality of print heads, and prior to printing a first image on the retransfer material. The control also is configured such that a single print command is issued to allow synchronous printing among the plurality of print heads.

It also will be appreciated that, in appropriate circumstances, not all of the print stations 112b-f after the first print station 112a, must have a sensor 116. For example, where any of the respective print stations 112b-f is not used for printing on portions of a retransfer material having a predisposed artifact, such a respective print station may not have a need for a sensor to detect the presence of a predisposed artifact.

With further reference to the sensor(s), each sensor 116 used is configured to determine a position of a predisposed artifact on the retransfer material 120. As shown, each the sensor 116 is a photocell. In other examples, the sensor 116 could be a holographic sensor, a proximity sensor, or suitable detector that can sense the presence or absence of an artifact. However, it will be appreciated that the sensor 116 could be other suitable detector technology that can be adapted for purposes of this disclosure.

In one embodiment, the sensor 116 is configured to detect an indicia mark (further described with respect to FIG. 3) on the retransfer material 120. In some embodiments, the indicia mark is an opaque area on the retransfer material 120. However, it will be appreciated that the indicia mark could be another marking that is not an opaque area, and may be dependent for example, on the detector technology employed.

As described above, the printer 100 has a control. When the sensor 116 detects an indicia mark on the retransfer material 120, such information is relayed to the control indicating the presence of a predisposed artifact. The position of the predisposed artifact is then obtained by the control. The control is configured to issue a command to position the retransfer material 120 with respect to the print head 114, based on the position of the predisposed artifact. Further, the control is configured to issue a command to the print head to print an image on the retransfer material without printing on the predisposed artifact.

With further reference to the control, the control of the printer can be configured to apply a configurable offset to further adjust the retransfer material to the print head. In some embodiments, this offset is used by the print system control board (e.g. one per system) to inform the local print control board (e.g. one for each print head) when to initiate a print cycle. Such system and local control boards are well known and may be configured as appropriate to carry out the control needed/desired.

With further reference to the printer 100, the retransfer material 120 is shown as a roll disposed on a supply side of the printer 100. A cylinder or drum 118 is used to draw and circulate the retransfer material 120 from the supply side, through each or the print stations 112a-f, and to a mating and image transfer station 122. At the image transfer station 122, images printed on the retransfer material and any predisposed artifacts already on the supply of retransfer material are transferred to a card (not shown).

A card transfer mechanism 124 is used to allow entry of cards or identity documents into the printer module 100 and to allow exit therefrom. Used retransfer material (i.e. after transfer of images and predisposed artifacts) is taken up by a take up side 126, such as a spindle.

Where appropriate, the printer 100 described herein (and methods) may be incorporated, for example, as a part of an identification document issuance system (e.g. in either small or large batch systems). Such a system would include a plurality of card processing modules, where one of the card processing modules is a printer 100 configured to perform any of the methods described herein. That is, the printer 100 (and the method 10) for example, can be incorporated as one of two or more processing modules in a card issuance system for producing identification documents.

### Further Printer/System Examples

With further reference to the printer 100, it will be appreciated that current printer hardware and firmware may be adapted and used to carry out printing applications described herein. Such printers include for example, thermal image transfer printers. As one example, U.S. Pat. No. 6,262,755 and US Patent Publication No. 2007/0199467 to DataCard Corporation of Minneapolis, Minn., which are incorporated herein by reference in their entirety, describe examples of multicolor thermal printing apparatuses. It will be appreciated however, that other printer types that are not thermal printers may be employed.

U.S. Pat. No. 6,262,755, for example, generally describes an apparatus and method for multi-color printing on plastic cards, such as credit cards, identification cards, and the like. The printing apparatus includes a rotatably driven cylinder or drum having a smooth, high friction outer surface, and a plurality of color print stations spaced circumferentially about the cylinder. A receptor web supply roll is mounted adjacent to the cylinder and supplies an uninterrupted length of a receptor web to the outer surface of the cylinder. The receptor web is frictionally engaged with the outer surface of the cylinder such that the web rotates therewith when the cylinder is rotated. A stepper motor and gearing assembly is connected to the cylinder for rotating the cylinder, and therefore the receptor web that is disposed on the outer surface thereof, to position the receptor web relative to the color print stations. The stepper motor and gearing assembly allow precise positioning of the cylinder and the receptor web relative to each print head, to ensure precise print registration.

With some reference to details of the print stations in U.S. Pat. No. 6,262,755, each of the print stations can be identical in construction, similar to the print stations 112a-f of FIG. 2 described above. The print stations are for printing color images and have thermal print heads, although other types of print heads can be used if appropriate and/or desired.

The print heads can be mounted so as to be moveable in a radial direction relative to the cylinder between a non-print position, at which no printing takes place, and a print position, at which printing occurs. The mechanical mounting of print heads to permit such movement is conventional in the art, and therefore no further description of the details of the mounting is provided.

With reference to how the apparatus functions in U.S. Pat. No. 6,262,755, spaced images can be printed on the receptor web. The first print station begins the printing of one of the images onto the web. During this time the cylinder is rotated, thereby moving the web relative to the first print head of the first print station, so that the first print station can print the first color at the desired location(s) over the entire extent of the intended image. Once the first print station is finished printing, the first image is brought into registration with the second print station. Simultaneously, the first print station is ready to start printing a second image onto the web, with the second image being spaced from the first image. The second print station performs printing on the first image in the second color, and then the first image is then brought into registration with the third print station. This process is repeated until the first image is brought into registration with each remaining print station so that the desired color image is completely printed onto the web. The use of multiple print stations disposed around the cylinder allows a plurality of images to be printed at the same time, thereby increasing the throughput of the printer.

Once printing of the first image is completed, the first image is then mated with a card in a mating and image transfer station, to permit transfer of the topping layer and the ink receptor layer of the web onto the plastic card, thereby transferring the image onto the card. It should be apparent to a person having ordinary skill in the art that the length of each printed image on the web should be chosen so that the image is able to fit completely onto the card.

Such thermal image transfer printers have been available commercially by DataCard Corporation. As one particular example, its current Artista® VHD retransfer printing module can print full or multiple color (cyan, magenta, yellow, key—CMYK) images along with an optional spot color on a continuous retransfer web. The print operation is continuous at about a speed of 1.7″/second for a production output of about over 1600 cards per hour. The retransfer material used in the current product is a continuous roll that can produce up to about 6000 printed images with no splices allowed within the roll. In current retransfer materials for this printer, the end of the roll is denoted by the presence of an opaque strip that will pass through and block a photocell. The photocell is used to indicate the near end of the retransfer material supply roll, e.g. out of retransfer material condition. On breaking the photocell, the system stops printing any further images, but finishes printing the images currently on the drum. An out of retransfer material condition is then reported a controller, and a system operator is prompted to replace the spent roll of retransfer material. However, such current rolls of retransfer material do not have index marks other than the one used to mark the end of the usable roll and do not use the current index mark for avoiding printing on a predisposed artifact.

### Embodiments of Methodology in Operation

In order to allow printing on a retransfer material that already has a predisposed artifact, for example a preprinted artifact, such as a hologram or other registered artifact, the indicia mark can be positioned so that a sensor can be used to detect the indicia mark, which would denote the end of a registered artifact, rather than the end of the retransfer material roll. For example, at least one indicia mark would be disposed from the beginning of a portion of retransfer material on the roll, namely, the portion(s) that have the predisposed artifact(s). In the example of the Artista® VHD retransfer printer module, since the physical spacing of the print heads around the print drum is about 3.85 inches, it is desirable to have the indicia marks match the spacing of the print heads.

Once the indicia mark passes through the photocell a configurable offset may be used to further position and adjust the retransfer material under the first print head being used by that particular print job, so that the preprinted artifact will be in the correct position after the image has been printed. As described, it will be appreciated that the firmware of the control board implementation employed can be suitably configured to determine the offset needed and provide the correct command in positioning the retransfer material.

As described above with respect to FIG. 1, one embodiment of this capability registers the indicia mark only once prior to printing the first image after the cylinder or print drum has been stopped. As described above, once printing has started, printing is continuous until an error occurs or the job has been completed. In either case, the print heads are retracted. The drum then continues until all printed images have been mated to their appropriate cards. Once done, the drum is then stopped until the error condition has been fixed or another print job has been initiated. The drum also stops when the system is paused by request of the operator. On pausing the system the current print cycle is completed before the print heads are retracted. The drum is then stopped when the latest completed image has been applied to its appropriate card.

In this embodiment, the indicia marks are placed accurately across the surface of the RTM, and assumes the print head spacing as well as the rotational speed of the print drum has been configured properly. Variance in the position of the indicia marks may cause a registered artifact to be placed inconsistently within the printed image.

In this embodiment, for example, it is desired to have the predisposed artifact, e.g. holographic material, spaced at every 3.85 inches on the retransfer web, that each “panel” where an image is to be disposed includes an indicia mark, which may be an opaque area printed on the retransfer web material. The indicia mark(s) can be detected and read by the sensor of the printer which uses the information to position the retransfer web and predisposed artifact, so that the images are printed properly. The indicia mark can also be used downstream to register the identification document/card to the printed images and predisposed artifact. In this embodiment, once the print process is started, all color heads begin printing at relatively the same time, with whatever mechanical offset required being handled by shifting the image in firmware.

For example, the print heads are controlled by a single control board, which starts a print cycle. The print cycle is started synchronously in response to a PRINT_START command issued to the control board by a driver executed by a control board embedded within the module. A second PRINT_START command can then be issued to the sixth print head. Mechanical variance caused by tolerance buildup is compensated for by shifting the canvas being printed by the print head, for example, a number of pixels (+/−64). Such shifting will allow the canvas to be shifted in order to align the different color canvases. For example, it will be appreciated that each of the six print heads utilizes an offset unique to that head. Such offset basically allows the image to be shifted earlier or later to align the canvases on top of each other. While the distance between each print head usually is fixed, e.g. at 3.5″, offsets are still employed to accommodate mechanical tolerances in the system. Typically, in systems not using a registered hologram, this offset is typically zero for the first print head, and the remaining five heads are adjusted to align to the image printed by the first head.

However, in the event that the indicia mark varies across the surface of the web the image will be placed incorrectly on the web in relation to the preprinted holographic image. This embodiment may be more suitable for shorter runs (<100 documents/cards) per job since the registration only occurs on the start (or restart) of a print job.

It will be appreciated that this embodiment can be implemented at relatively no additional cost to existing printer hardware, such as described above. Although the ability of detecting the end of the retransfer material roll may be lost due to that sensor now being used to sense the indicia mark, the retransfer material supply can be calculated using a quadrature encoder on the supply core of the retransfer material spindle. Currently this portion of the printer firmware uses that encoder to estimate how much retransfer material remains on the supply spool, but allows printing to continue until the retransfer material end mark is detected. So this encoder could be modified to make the determination based solely on the amount of material left on the supply.

In another embodiment of independently controlled print heads, a same physical configuration of the printer may be used, however, modification would be made to the print head firmware that resides on the printer control board. With such a configuration, it is possible to reduce if not eliminate the potential for the retransfer web material to be out of position, so as to better ensure that the predisposed artifact, e.g. holographic image, is positioned properly. Also, it can allow the predisposed artifacts to be placed more randomly on the retransfer web material. This embodiment could be more suitable for various sized print jobs, including relatively larger print jobs.

In this embodiment, for example, separate PRINT_START commands would be issued independently to each print head and would result in each print head having independent control. This configuration would allow the indicia marks to be randomly disbursed across the retransfer material. In some embodiments, it is desired to have the indicia mark to print head distance be a fixed distance that is adjustable via a configurable offset such that each color canvas would be triggered to begin printing when the indicia mark has passed through the photocell and the cylinder/drum has been stepped the offset distance.

In this embodiment, each print head would be under independent control, and would print a different canvas. That is, each print head may be somewhat under a delayed control as appropriate, depending on what is happening upstream or downstream. In such a control configuration, each print head is independent of the others, whereby a print head does not initiate a print cycle until its appropriate indicia mark has passed through that respective head's sensor. A configurable offset would then be applied (in terms of drum motor steps) to ensure the appropriate portion of the RTM web is under the print head when the print cycle begins.

At any given time the print heads are printing their specific color canvas that make up the image. In one example, print heads may be configured as depicted below:

| | | | Distance from |
|---|---|---|---|
| | | | Indicia Sensor |
| Head 1 | Cyan | Image 6 | 3.85″ |
| Head 2 | Magenta | Image 5 | 7.70″ |
| Head 3 | Yellow | Image 4 | 11.55″ |
| Head 4 | Black | Image 3 | 15.40″ |
| Head 5 | Spot | Image 2 | 19.25″ |
| Head 6 | Printer | Image 1 | 23.10″ |

For example, the table above shows that when the first indicia mark is detected, Head 1 (Cyan) will begin printing the Cyan canvas of Image 1 when the drum advances the retransfer material 3.85 inches (or whatever the configured distance is between the Head 1 print head, and the indicia sensor). Head 2 (Magenta) will not begin printing the Magenta canvas of Image 1 until the drum has advanced the retransfer material 7.70 inches past the indicia sensor. The 7.70 inch distance may be adjusted as need by a configuration offset used to align the color image planes. As the Image progresses around the cylinder (or drum) each print head will contribute its color plane until the completed images rolls off the print drum. In one embodiment, after Head 1 prints the Cyan canvas of the first image, Head 1 will not begin printing the next image until the next indicia mark is detected. It also will be appreciated that in certain circumstances, where appropriate, once an indicia mark is detected, start times for the respective print heads can be calculated and stored. These start times can be applied for configuring the print drum motor steps. For example, each step may be 0.00034545″, for example due to the gearing of the print drum motor and drum diameter, each motor step advances the print drum 0.00034545 inches. It will be appreciated that this value is merely exemplary and for example is applicable to the printer shown in FIG. 2, such as the Artista® VHD printer. It will be appreciated that the step can vary as needed/desired. For example, since the outer diameter of the print drum can vary (due to manufacturing tolerances) and thus the distance per step can vary. Thus, the drum motor step speed can be changed, as well as the offset parameters. The speed variance is allowed to increase or decrease the length of the image and the offset parameters are used to position the image correctly.

### Retransfer Material

With reference to FIG. 3, an embodiment of a retransfer material 200 is shown that may be employed, for example in the method of FIG. 1 and printer of FIG. 2. FIG. 3 generally shows a predisposed artifact, e.g. a registered hologram, on a surface of the retransfer material.

In one embodiment, the retransfer material 200 is a continuous web material for printing an image on the retransfer material for transfer onto an identification document. As appropriate, the retransfer material is pigment receptive, and allows transfer of an image printed on the material to a document/card by way of heat and pressure. In some circumstances, the resulting image and printed material is a thin layer of material that can be thermally transferred from the retransfer material (or web) onto a document or card. The thin layer, may be for example, about 0.5 μm.

In one embodiment, the retransfer material 200 may be a roll of web material having a plurality of panels 202. It will be appreciated that the web material can be constructed of a length suitable with numerous panels for printing images thereon, for example about 6000 panels. FIG. 3 shows an unrolled portion of the retransfer material. Each respective panel 202 has a major area with a designated printing area within the major area. At least one predisposed artifact 204 is disposed within the major area of at least one panel 202, but is outside the respective designated printing areas. As shown in FIG. 3, images 210, 212 can be printed on the retransfer material 200, i.e. see area of panels 202 outside the area of the predisposed artifacts 204. As shown, the first panel from the left is a blank (i.e. image not yet printed), the middle panel has an image 210, and the right panel has an image 212, which may be different than the image 210, but could be the same.

As shown, a plurality of predisposed artifacts 204 is on the web material, and more particularly where only one predisposed artifact 204 is on each panel 202. It will be appreciated that a panel may include more than one predisposed artifact 204, and some panels 202 may not include a predisposed artifact.

A code portion 206 is disposed outside of each respective panel 202. In one embodiment, the code portions 20 identify at least one image that should be printed on the respective panel 202. In one embodiment, the code portions 206 are a bar code preprinted on a side of the respective panel of the retransfer material.

As mentioned earlier the purpose of the indicia mark is to ensure the artifact (hologram) is located on the same spot of each printed card. It may or may not be desirable to print on or around the artifact. The purpose of the printed bar code is to ensure the proper image is applied to the proper card. A partially personalized card (mag stripe, smart card) may enter the VHD system and must be mated with a specific image (the owner's face) that matches the partially personalized card. The bar code that is printed is associated with the data passed to the VHD module from the system controller and will be tightly coupled with the personalized data for that card. In addition to identifying the image the bar code is used to physically align the printed image with the card so the edge of the image is applied on the edge of the card. All indicia marks, printed and preprinted are located outside the printed area of the image that is to be applied to the card.

An indicia mark 208 is disposed outside at least one panel 202. As shown, each panel 202 has an indicia mark, as each panel has a predisposed artifact 204. That is, an indicia mark 208 is provided for each respective panel 202 having a predisposed artifact 204. In the embodiment shown, each indicia mark 208 is disposed outside the respective panel 202. It will be appreciated, however, that not all panels must require an indicia mark, for example where a panel does not have a predisposed artifact. In one embodiment, the indicia marks 208 are an opaque strip on the retransfer material 200. In some embodiments, the indicia marks 208 are disposed under the code portions 206 so that they may be easily detected by a sensor of the printer. In the embodiment shown, the indicia marks 208 are smaller relative to the code portions 206, for example, the height h of the indicia mark 208 is smaller than that of the code portion 206 (see left panel).

With further reference to the arrangement of the code portions 206 and the indicia marks 208, the code portions 206 and the indicia marks 208 (when present) can be arranged on an upstream side of the respective panel 202, for such panels having a predisposed artifact 204 thereon. In one embodiment, the code portions 206 and the indicia marks 208 can take up about the same width w on the retransfer material 200. In one embodiment, a distance d from each code portion 206 and indicia mark 208 (if present) and panel 202 to the next set of code portion/indicia mark/panel, can be arranged to correspond with spacing of print heads in a multiple print head retransfer color printer, e.g. as described above. For example, the distance d can be approximately 3.85 inches, such as for instance the spacing used in some current thermal transfer printers.

This methods and printer/system implementations described herein can be used to control the printing of images, including color images, onto a predisposed artifact, such as a registered holographic retransfer material in a continuous web form. Before the disclosure herein, current processes would print images on a continuous retransfer web with no relation between the printed image and the continuous web. The concepts and implementations herein can provide the correlation required to position a preprinted holographic image on the image being printed on the retransfer web.

Further, it is possible for a retransfer printer to use preprinted holographic retransfer material and to position the preprinted hologram at a specific location with respect to the image(s) printed on the retransfer material or web. The image(s), and hologram, can then be transferred to an identification document or card.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method for printing an image on a retransfer material for subsequent transfer onto an identification document comprising:
passing a retransfer material through a sensor, the retransfer material having an indicia mark thereon;
detecting the indicia mark with the sensor to obtain a position of a predisposed artifact on a surface of the retransfer material;
positioning the retransfer material with respect to a print head of a printer, based on the position of the predisposed artifact; and
printing an image onto the retransfer material.

2. The method of claim 1, wherein printing comprises printing the image such that it is not printed onto the predisposed artifact.

3. The method of claim 1, wherein the retransfer material includes a plurality of predisposed artifacts thereon.

4. The method of claim 1, wherein the step of printing comprises printing a plurality of images on the retransfer material.

5. The method of claim 1, wherein the step of printing comprises printing at least one image on multiple panels of the retransfer material, each panel having a major area with a designated printing area within the major area of the respective panel, where at least one predisposed artifact is disposed within the major area of one or more of the panels on the retransfer material but outside the respective designated printing area.

6. The method of claim 1, wherein the steps of passing, sensing, and positioning occur only once with respect to a first print head in a plurality of print heads, and prior to printing a first image on the retransfer material, such that a single print command is issued to allow synchronous printing among the plurality of print heads.

7. The method of claim 1, wherein the steps of passing, sensing, and positioning occur for each print head in a plurality of print heads, such that a separate print command is independently issued to each print head to allow printing at the respective print head, when the steps of passing, sensing, and positioning have been satisfied at the respective print head.

8. The method of claim 1, wherein the step of positioning comprises applying a configurable offset to adjust the retransfer material to the print head.

9. A printer for printing an image on a retransfer material for subsequent transfer onto an identification document comprising:
at least one print station;
a print head for each print station;
a sensor disposed proximate at least one of the print stations, the sensor is positioned prior to an upstream side of the print head; and
a control,
the sensor is configured to determine a position of a predisposed artifact on a retransfer material, the control is configured to issue a command to position the retransfer material with respect to the print head based on the position of the predisposed artifact, and the control is configured to issue a command to the print head to print an image on the retransfer material.

10. The printer of claim 9, wherein the control is configured to print the image on the retransfer material without printing on the predisposed artifact.

11. The printer of claim 9, wherein the printer is configured to print multiple images on the retransfer material.

12. The printer of claim 9, wherein the images are color images.

13. The printer of claim 9, wherein the control is configured to position the retransfer material only once with respect to a first print head in a plurality of print heads, and prior to printing a first image on the retransfer material, and the control is configured such that a single print command is issued to allow synchronous printing among the plurality of print heads.

14. The printer of claim 9, wherein the control is configured to position the retransfer material at each print head in a plurality of print heads, and the control is configured such that a separate print command is independently issued to each print head to allow printing at the respective print head, when the retransfer material has been positioned.

15. The printer of claim 9, wherein the control is configured to apply a configurable offset to further adjust the retransfer material to the print head.

16. The printer of claim 9, wherein the sensor is a photocell configured to detect an indicia mark on the retransfer material.

17. The printer of claim 9, wherein the indicia mark is an opaque area on the retransfer material.

18. A card issuance system for producing identification documents, comprising a plurality of card processing modules, one of the card processing modules is a printer according to claim 9.

19. A retransfer material for printing an image on the retransfer material for transfer onto an identification document comprising:
a continuous web material having a plurality of panels, each respective panel has a major area with a designated printing area within the major area;
at least one predisposed artifact within the major area of at least one panel, but outside the respective designated printing area;
a code portion disposed outside of each respective panel, the code portion identifies at least one image that should be printed on the respective panel; and
an indicia mark disposed outside at least one panel.

20. The retransfer material of claim 19, wherein the indicia mark is an opaque strip on the retransfer material.

21. The retransfer material of claim 19, further comprising an indicia mark for each respective panel having a predisposed artifact, each indicia mark is disposed outside the respective panel.

22. The retransfer material of claim 19, wherein the code portion is a bar code preprinted on a side of the respective panel of the retransfer material.

23. The retransfer material of claim 19, wherein the code portion and the indicia mark are both arranged on an upstream side of the respective panel having a predisposed artifact thereon, the code portion and the indicia mark take up about the same width dimension on the retransfer material.

24. The retransfer material of claim 19, comprising a plurality of predisposed artifacts on the continuous web material.

25. The retransfer material of claim 19, comprising an indicia mark for each panel.

26. The retransfer material of claim 19, wherein the predisposed artifact is a registered hologram.

27. The retransfer material of claim 19, wherein the continuous web material is arranged as a roll of web material.
